(19) United States
(12) Patent Application Publication
(10) Pub. No.: US 2010/0037209 A1
(43) Pub. Date: Feb. 11, 2010

(54) SOURCE PROGRAM REVIEW PROGRAM, SOURCE PROGRAM REVIEW METHOD, AND SOURCE PROGRAM REVIEW DEVICE

(75) Inventor: Koji Sasaki, Yokohama (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/571,843

(22) Filed: Oct. 1, 2009

Related U.S. Application Data
(63) Continuation of application No. PCT/JP2007/057852, filed on Apr. 9, 2007.

(51) Int. Cl. G06F 9/44

(52) U.S. Cl. 717/123

(57) ABSTRACT

A method for reviewing a modified source program includes extracting review-requiring points to be reviewed, by comparing a pre-modification source program as a source program before a modification and a post-modification source program as a source program after the modification, storing a review history indicating whether each of the review-requiring points extracted at the extracting has been reviewed or is unreviewed, outputting information of the review-requiring points extracted in the extracting, associated with the review history stored in the storing and indicating whether each of the review-requiring points has been reviewed or is unreviewed, to a predetermined output unit, and updating the review history stored in the storing when receiving from a predetermined input unit that the review-requiring point outputted as unreviewed by the predetermined output unit has been reviewed.

### CROSS-REFERENCE TO RELATED APPLICATION(S)

This application is a continuation of PCT international application Ser. No. PCT/JP2007/057852 filed on Apr. 9, 2007 which designates the United States, the entire contents of which are incorporated herein by reference.

### FIELD

The embodiments discussed herein are directed to a source program review program, a source program review method, and a source program review device.

### BACKGROUND

Conventionally, modification of an existing source program to add new functions or update functions is commonly performed to develop new software.

In the software development, it is important that the existing source program be modified based on design specifications describing processes to be added or updated, and then each software developer review the modified source program.

In the review operation, items such as “Are processes to be added or updated, described in design specifications, implemented in the modified source program?”, “Are execution theories at added or updated points correct in the modified source program?”, “Are description formats at the added or updated points correct in the modified source program?”, and “Are there points influenced by the added or updated points in the modified source program?”are reviewed by the software developers.

Specifically, each software developer refers to (or visually confirms) a form printed with differential information obtained by comparing source programs before and after a modification to review the foregoing items, and lists problems on the modified source program. Upon confirmation by all the software developers that the review processes for all the listed problems are completed, the review operation ends.

Japanese Laid-open Patent Publication No. 63-273132 discloses a program development support system that enables to reduce burdens on software developers in a review operation by extracting change points in source programs before and after a modification and outputting the extracted change points on a screen.

Japanese Laid-open Patent Publication No. 08-190475 and Japanese Laid-open Patent Publication No. 11-327879 disclose a program analyzing device and a variable search device that enable to reduce burdens on software developers in a review operation by searching for points influenced by a source program change and outputting the influenced points on a screen.

In the conventional techniques, each software developer cannot leave any trace of a review of problems on the modified source program as a history, and therefore a highly-reliable review cannot be achieved.

That is, each software developer performs a visual review operation and accordingly cannot leave the trace of the review of the problems on the modified source program as the history. Therefore, a highly-reliably review cannot be achieved.

Further, the conventional techniques cannot leave as the history, whether each software developer has really reviewed the whole of a range that is recognized as “points influenced by a source program change”. Accordingly, a highly-reliable review cannot be achieved.

In the conventional techniques, when there is a difference between positional information of points to be reviewed before and after a modification of the source program (specifically, line numbers at which the points are described in the source programs), each software developer needs to update the positional information of the points to be reviewed and pursue the operation. Therefore, the burdens on the software developers cannot be reduced, and accordingly a highly-reliable review cannot be achieved.

### SUMMARY

According to an aspect of the invention, a method for reviewing a modified source program includes: extracting review-requiring points to be reviewed, by comparing a pre-modification source program as a source program before a modification and a post-modification source program as a source program after the modification; storing a review history indicating whether each of the review-requiring points extracted at the extracting has been reviewed or is unreviewed; outputting information of the review-requiring points extracted in the extracting, associated with the review history stored in the storing and indicating whether each of the review-requiring points has been reviewed or is unreviewed, to a predetermined output unit; and updating the review history stored in the storing when receiving from a predetermined input unit that the review-requiring point outputted as unreviewed by the predetermined output unit has been reviewed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A, 1B, 1C and 1D are schematic diagrams for explaining an outline and characteristics of a source program review device according to a first embodiment of the present invention;

FIG. 2 is a block diagram of a configuration of the source program review device according to the first embodiment;

FIGS. 3, 4, and 5 are schematic diagrams for explaining a source-program storage unit according to the first embodiment;

FIGS. 6 to 12, 13A to 13C, 14, and 15A to 15C are schematic diagrams for explaining a review-requiring-point extracting unit according to the first embodiment;

FIGS. 16A to 16C are schematic diagrams for explaining a review-history storage unit according to the first embodiment;

FIGS. 17 to 20 are schematic diagrams for explaining an information display unit according to the first embodiment;

FIG. 21 is a schematic diagram for explaining a process of extracting review-requiring points by the source program review device according to the first embodiment;

FIG. 22 is a schematic diagram for explaining a review-history updating process performed by the source program review device according to the first embodiment; and

FIG. 23 depicts a computer that executes a source program review program according to the first embodiment.

### DESCRIPTION OF EMBODIMENTS

Exemplary embodiments of a source program review program, a source program review method, and a source program review device according to the present invention will be explained below in detail with reference to the accompanying drawings. A source program review device including a source program review program according to the present invention is explained below as the embodiments. An outline and characteristics of a source program review device according to a first embodiment of the present invention, a configuration and a process procedure of the source program review device according to the first embodiment, and effects of the first embodiment are successively explained below, and then other embodiments of the present invention are explained at the end.

### [a] First Embodiment

### Outline and Characteristics of Source Program Review Device according to First Embodiment

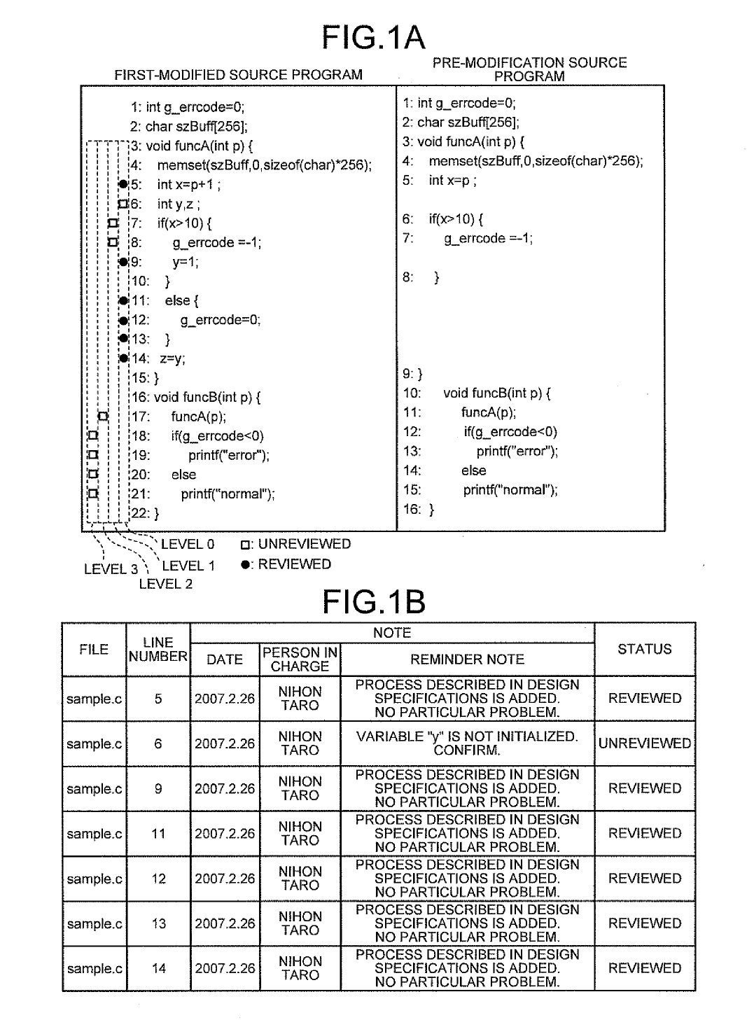

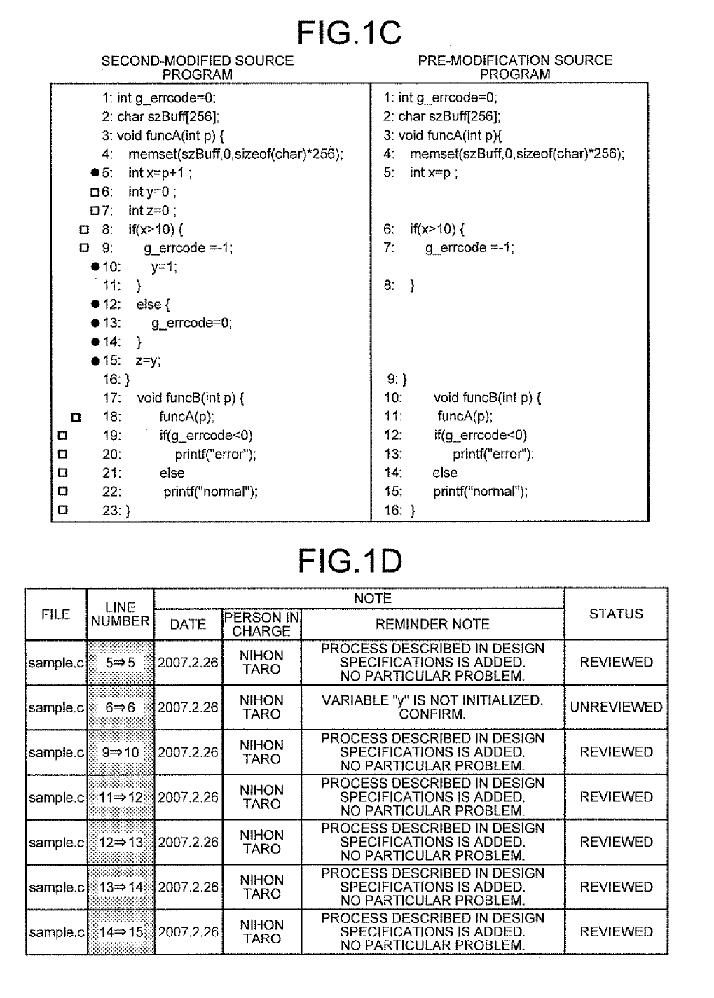

Main characteristics of a source program review device according to the first embodiment are specifically explained firstly with reference to FIGS. 1A to 1D. FIGS. 1A to 1D are schematic diagrams for explaining an outline and characteristics of the source program review device according to the first embodiment.

An outline of the source program review device according to the first embodiment is to review a modified source program. That is, the source program review device according to the first embodiment reviews a modified source program after a software developer modifies an existing source program based on design specifications that describe processes to be added or updated.

A main characteristic of the present invention is to provide a highly-reliable review. To simply explain the main characteristic, the source program review device according to the first embodiment compares a pre-modification source program which is a source program before a modification and a post-modification source program which is a source program after the modification, extracts review-requiring points which are points to be reviewed, associated with positional information in the post-modification source program, and further extracts as review-requiring points, modified points which are points modified from the pre-modification source program and influenced points which are points for which processes described in the post-modification source program are influenced by the modified points, being classified according to levels of the influences, in the post-modification source program.

For example, the source program review device according to the first embodiment compares a “pre-modification source program” as an existing source program and a “first-modified source program” as a post-modification source program obtained by first modification of the existing source program based on design specifications, and extracts review-requiring points associated with “line numbers” as positional information in the post-modification source program, as depicted in FIG. 1A.

The source program review device according to the first embodiment first extracts modified points in the “first-modified source program” which are points modified from the “pre-modification source program” as review-requiring points of a “level 0”. That is, as depicted in FIG. 1A, the source program review device according to the first embodiment compares the “first-modified source program” and the “pre-modification source program”, and extracts a “5th line” in which details of a function “funcA” are changed, a “6th line”, a “9th line”, and “11th to 14th lines” in which descriptions are added, as review-requiring points of the “level 0”.

The source program review device according to the first embodiment then extracts influenced points in which process flows are influenced by a point in which the details of the function are changed among the review-requiring points extracted as the “level 0”, as review-requiring points of a “level 1”. That is, as depicted in FIG. 1A, the source program review device according to the first embodiment extracts a “7th line” and a “8th line” which are influenced points in which process flows are directly influenced by the point in the “5th line” in which the details of the function “funcA” are changed among the review-requiring points of the “level 0”, as the review-requiring points of the “level 1”.

Further, the source program review device according to the first embodiment further extracts points referring to a “changed function” among the review-requiring points extracted as the “level 0”, as review-requiring points of a “level 2”. That is, as depicted in FIG. 1A, the source program review device according to the first embodiment extracts a “17th line” in which a process of a function “funcB” referring to the function “funcA” is described among the review-requiring points of the “level 0”, as a review-requiring point of the “level 2”.

The source program review device according to the first embodiment then extracts points influenced by the function in the review-requiring point extracted as the “level 2”, as review-requiring points of a “level 3”. That is, as depicted in FIG. 1A, the source program review device according to the first embodiment extracts “18th to 21st lines” that are influenced points in which process flows are directly influenced by the function “funcB” in the review-requiring point of the “level 2”, as the review-requiring points of the “level 3”.

The source program review device according to the first embodiment stores in a predetermined storage unit, a review history which is a history indicating whether each of the extracted review-requiring points has been reviewed or is unreviewed, associated with the positional information in the post-modification source program.

That is, the source program review device according to the first embodiment stores in the storage unit, a review history indicating whether each of the “5th line”, the “6th line”, the “9th line”, and the “11th to 14th lines” extracted as the review-requiring points of the “level 0”, the “7th line” and the “8th line” extracted as the review-requiring points of the “level 1”, the “17th line” extracted as the review-requiring point of the “level 2”, and the “18th to 21st lines” extracted as the review-requiring points of the “level 3” has been reviewed or is unreviewed. The source program review device according to the first embodiment stores in the storage unit, the review-requiring points of the “level 0” to the “level 3” as “unreviewed” until a review start request from the software developer is received.

The source program review device according to the first embodiment then outputs information of the extracted review-requiring points associated with the stored review history indicating whether they have been reviewed or are unreviewed, to a predetermined output unit. The source program review device according to the first embodiment receives a “level” designated by the software developer for the review-requiring points ranging from the “level 0” to the “level 3” through a predetermined input unit, and displays review-requiring points up to the designated “level”.

That is, when receiving a request to ‘display all review-requiring points up to the “level 3”’ from the software developer, the source program review device according to the first embodiment displays the “first-modified source program” and the “pre-modification source program” side by side on a monitor, and displays review-requiring points with “marks” placed at positions corresponding to the “level 0” to the “level 3”, respectively, on the left of the “line number” of the “first-modified source program”, for example as depicted in FIG. 1A. As the “marks” to be placed, an “outline rectangle (□)” denotes “unreviewed” and a “black dot ()” denotes “reviewed”.

FIG. 1A is an example in which the “5th line”, the “9th line” and the “11th to 14th lines” of the “level 0” are displayed with the “black dots ()” as the “marks” indicating “reviewed” placed thereto. When a request to ‘display all review-requiring points up to the “level 3”’ is received first from the software developer, the review-requiring points are displayed with the “outline rectangles (□)” as the “marks” indicating “unreviewed” placed at positions corresponding to the “level 0” to the “level 3”, respectively, on the left of the line numbers of all the review-requiring points.

The source program review device according to the first embodiment updates the stored review history when “reviewed” is received from the predetermined input unit for a review-requiring point outputted as unreviewed on the monitor. That is, for example when receiving a display change for changing a “status” to “reviewed” together with a “reminder note” to the effect that “Process described in design specifications is added. No particular problem.” for the “5th line”, the “9th line” and the “11th to 14th lines” of the “level 0” on “Feb. 26, 2007” from “NIHON Taro” as a software developer, the source program review device according to the first embodiment changes the “mark” from the “outline rectangle (□)” indicating “unreviewed” to the “black dot ()” indicating “reviewed” and displays the changed marks on the left of the line numbers as depicted in FIG. 1A, and updates the review history as depicted in FIG. 1B.

When the software developer “NIHON Taro” refers to the “6th line” of the “level 0” and determines that the problem is not solved (an initializing process for a variable “y” is not described), the source program review device according to the first embodiment accepts only a “reminder note” to the effect that “Variable “y” is not initialized. Confirm.” and does not change the “outline rectangle (□)” as the “mark” indicating “unreviewed” (see FIG. 1B). In the first embodiment, it is assumed that the software developer “NIHON Taro” reviews only the review-requiring points of the “level 0” and terminates the process.

It is assumed here that the review of the “first-modified source program” is completed in a situation depicted in FIG. 1B, and a software developer creates a “second-modified source program” by modifying the “first-modified source program” based on a result of the review. That is, it is assumed that a software developer that refers to the reminder note to the effect that “Variable “y” is not initialized. Confirm.” of the “6th line” as the review-requiring point of the “level 0” in the review history depicted in FIG. 1B creates a “second-modified source program” as depicted in FIG. 1C by modifying the “first-modified source program” depicted in FIG. 1A. In the “second-modified source program”, “6: int y,z;” in the “first-modified source program” is divided into two lines of “6: int y=0;” and “7: int z=0;”. An initial value of the variable “y” is set to “0” in the “6th line”, and an initial value of a variable “z” is newly set to “0” in the “7th line”.

The source program review device according to the first embodiment that stores therein the “second-modified source program” then compares the “second-modified source program” and the “first-modified source program”, and extracts review-requiring points associated with positional information (line numbers) in the “second-modified source program”.

That is, the source program review device according to the first embodiment that stores therein the “second-modified source program” extracts the points in the “5th line”, the “6th line”, the “9th line”, and the “11th to 14th lines” extracted as the review-requiring points of the “level 0” in the “first-modified source program”, associated with the “5th line”, the “6th line”, the “10th line”, and the “12th to 15th lines” as line numbers in the “second-modified source program”. The source program review device also extracts the points in the “7th line” and the “8th line” extracted as the review-requiring points of the “level 1” in the “first-modified source program” associated with the “8th line” and the “9th line” as line numbers in the “second-modified source program”. The source program review device further extracts the point in the “17th line” extracted as the review-requiring point of the “level 2” in the “first-modified source program” associated with the “18th line” as a line number in the “second-modified source program”, and extracts the points in the “18th to 21st lines” extracted as the review-requiring points of the “level 3” in the “first-modified source program” associated with “19th to 22nd lines” as line numbers in the “second-modified source program”. The source program review device also extracts the “7th line” as a review-requiring point of the “level 0” in the “second-modified source program”.

Accordingly, when receiving again the request to ‘display all review-requiring points up to the “level 3”’ from the software developer, the source program review device according to the first embodiment updates the “line numbers” in the review history as depicted in FIG. 1B with the “line numbers” in the “second-modified source program”, and displays the “second-modified source program” and the “pre-modification source program” side by side as depicted in FIG. 1C based on the updated review history. The source program review device also displays the review-requiring points with “marks” placed at positions corresponding to the “level 0” to the “level 3”, respectively, on the left of the “line numbers” of the “second-modified source program”.

That is, as depicted in FIG. 1D, the source program review device updates the “5th line”, the “6th line”, the “9th line”, and the “11th to 14th lines” as the line numbers of the points extracted as the review-requiring points of the “level 0” in the “first-modified source program” with the “5th line”, the “6th line”, the “10th line”, and the “12th to 15th lines” as the line numbers of the “second-modified source program”. The source program review device then displays the review-requiring points with “marks” placed at positions corresponding to the “level 0” to the “level 3”, respectively, on the left of the updated “line numbers” in the “second-modified source program”.

In this way, the source program review device according to the first embodiment leaves the trace of the review of each software developer as the history, and enables the software developers to share the points to be reviewed. Therefore, a highly-reliable review as described above as the main characteristic can be achieved.

### Configuration of Source Program Review Device according to First Embodiment

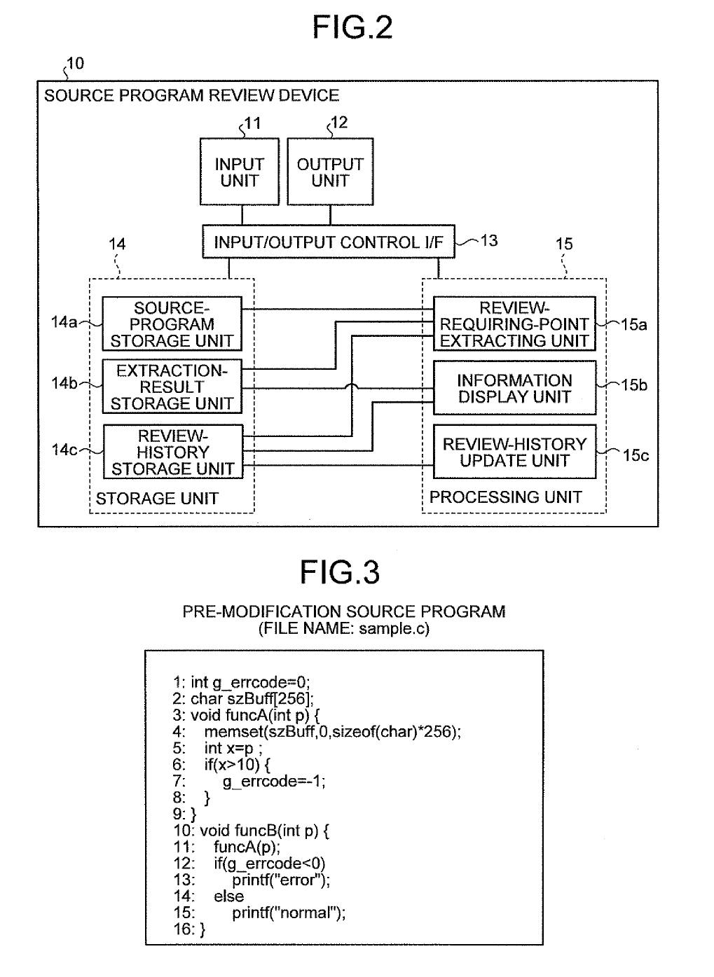

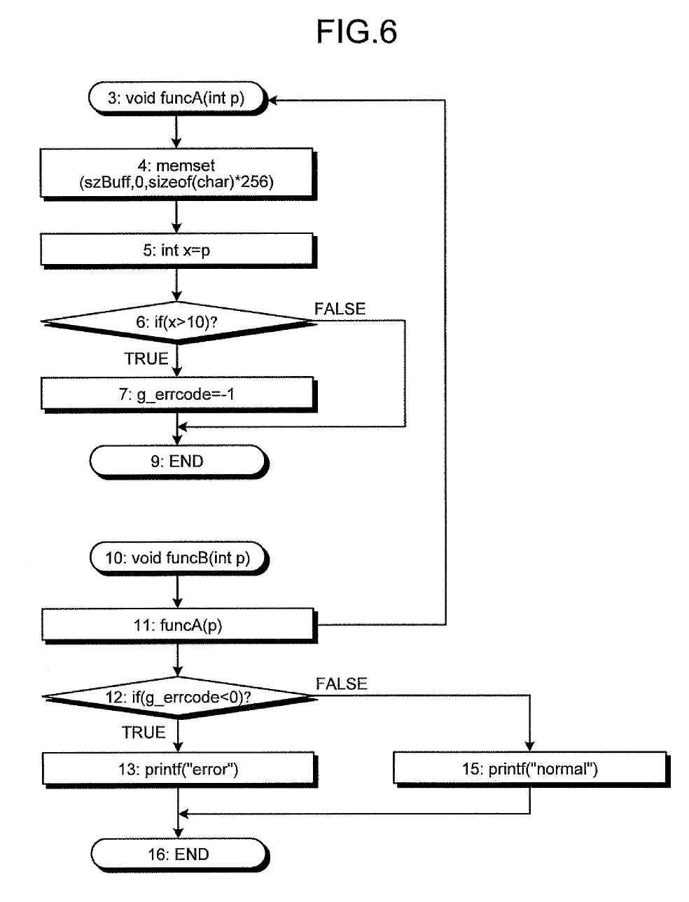

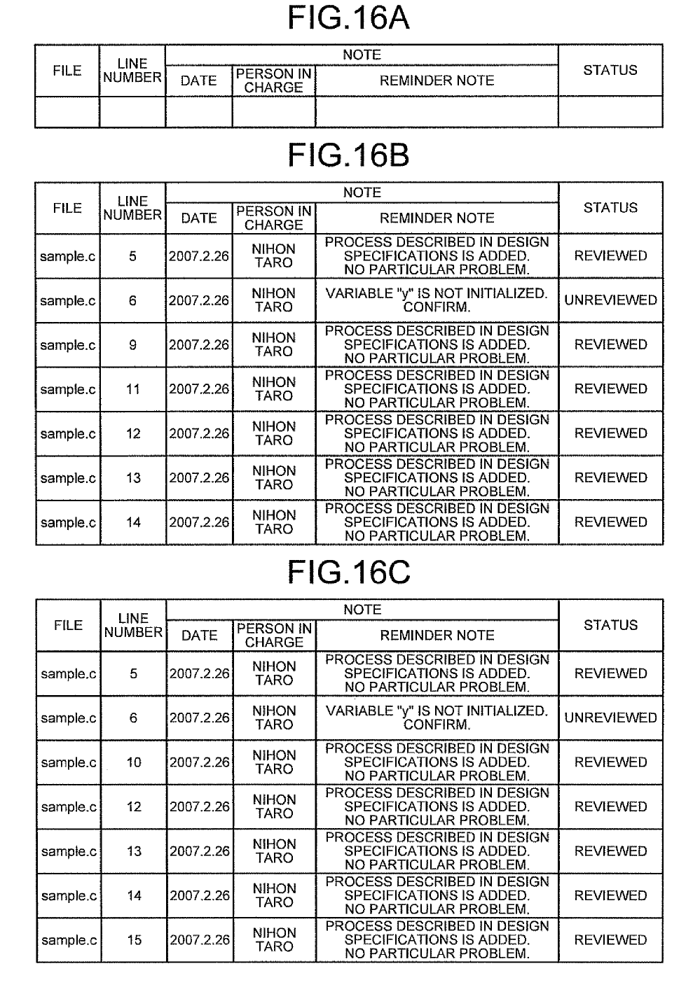

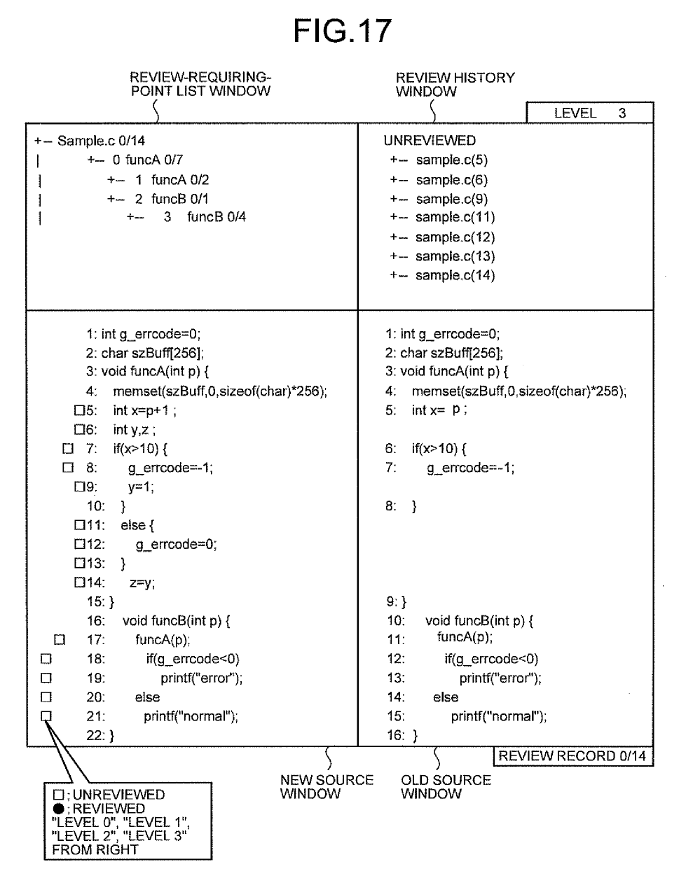

The source program review device according to the first embodiment is explained with reference to FIGS. 2 to 20. FIG. 2 is a block diagram of a configuration of the source program review device according to the first embodiment. FIGS. 3 to 5 are schematic diagrams for explaining a source-program storage unit according to the first embodiment. FIGS. 6 to 14, and FIGS. 15A to 15C are schematic diagrams for explaining a review-requiring-point extracting unit according to the first embodiment. FIGS. 16A to 16C are schematic diagrams for explaining a review-history storage unit according to the first embodiment. FIGS. 17 to 20 are schematic diagrams for explaining an information display unit according to the first embodiment.

As depicted in FIG. 2, a source program review device 10 according to the first embodiment includes an input unit 11, an output unit 12, an input/output control interface (I/F) 13, a storage unit 14, and a processing unit 15.

The input unit 11 includes a keyboard, a mouse, and the like to input various kinds of information. The input unit 11 receives from the keyboard, for example, “storage of a source program”, “request to display review-requiring points”, “designation of a level of review-requiring points”, or “update of a review history”, particularly as information closely related to the present invention.

The output unit 12 includes a monitor, a speaker, and the like to output various kinds of information. The output unit 12 displays a result of a process performed by an information display unit 15b described later on a screen of the monitor, for example, particularly as the information closely related to the present invention.

The input/output control I/F 13 controls data transfer between the input unit 11 or the output unit 12, and the storage unit 14 or the processing unit 15.

The storage unit 14 stores therein data to be used for various processes performed by the processing unit 15 and results of the various processes by the processing unit 15. The storage unit 14 includes a source-program storage unit 14a, an extraction-result storage unit 14b, and a review-history storage unit 14c particularly as components closely related to the present invention, as depicted in FIG. 2. The review-history storage unit 14c performs a procedure to store review history.

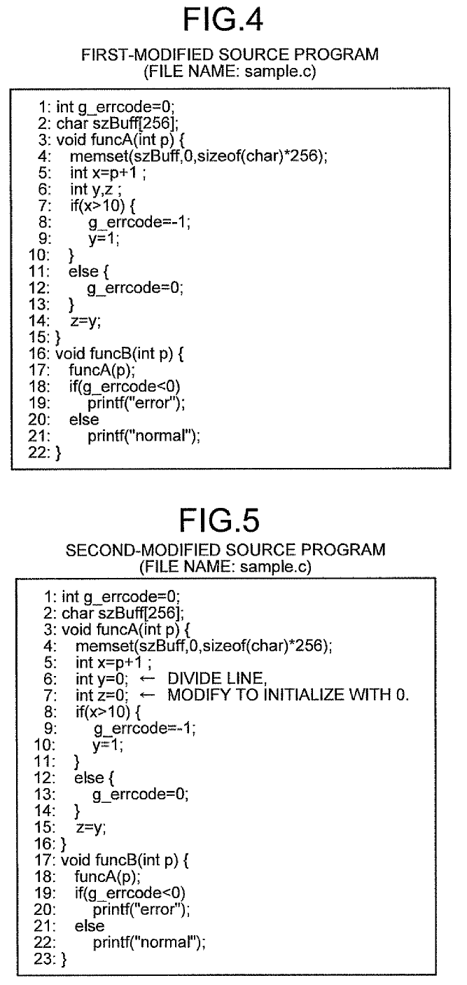

The source-program storage unit 14a stores therein a pre-modification source program which is a source program before modifications, and post-modification source programs which are source programs after the modifications. Specifically, the source-program storage unit 14a stores therein a “pre-modification source program” as an existing source program as depicted in FIG. 3, and a “first-modified source program” as a post-modification source program obtained by first modification of the “pre-modification source program” based on design specifications as depicted in FIG. 4. The source-program storage unit 14a also stores therein a “second-modified source program” as depicted in FIG. 5, obtained by the software developer that further modifies the “first-modified source program” by referring to a review history stored in the review-history storage unit 14c described later. It is assumed that the “source programs” depicted in FIGS. 3 to 5 are all stored as files of “file name: sample.c” written in a C language.

The extraction-result storage unit 14b stores therein a result extracted by a review-requiring-point extracting unit 15a described later. The review-history storage unit 14c stores therein a review history as a history indicating whether each of review-requiring points extracted by the review-requiring-point extracting unit 15a has been reviewed or is unreviewed. The extraction-result storage unit 14b and the review-history storage unit 14c are explained later in detail.

The processing unit 15 performs various processes based on the data transferred from the input/output control I/F 13. The processing unit 15 includes the review-requiring-point extracting unit 15a, the information display unit 15b, and a review-history update unit 15c particularly as components closely related to the present invention, as depicted in FIG. 2. The review-requiring-point extracting unit 15a performs a procedure to extract review-requiring points. The information display unit 15b performs a procedure to display information, and the review-history update unit 15c performs a procedure to update review history.

The review-requiring-point extracting unit 15a compares the pre-modification source program and the post-modification source program stored in the source-program storage unit 14a, and extracts review-requiring points which are points to be reviewed, associated with positional information in the post-modification source program. The review-requiring-point extracting unit 15a further extracts as review-requiring points, modified points in the post-modification source program, which are points modified from the pre-modification source program, and influenced points for which processes described in the post-modification source program are influenced by the modified points, classified according to levels of the influences, and stores results of the extractions in the extraction-result storage unit 14b.

The review-requiring-point extracting unit 15a first compares the “pre-modification source program” depicted in FIG. 3 and the “first-modified source program” depicted in FIG. 4, and extracts modified points in the “first-modified source program”, which are points modified from the “pre-modification source program”, as review-requiring points of the “level 0” associated with “line numbers” as positional information in the “first-modified source program”.

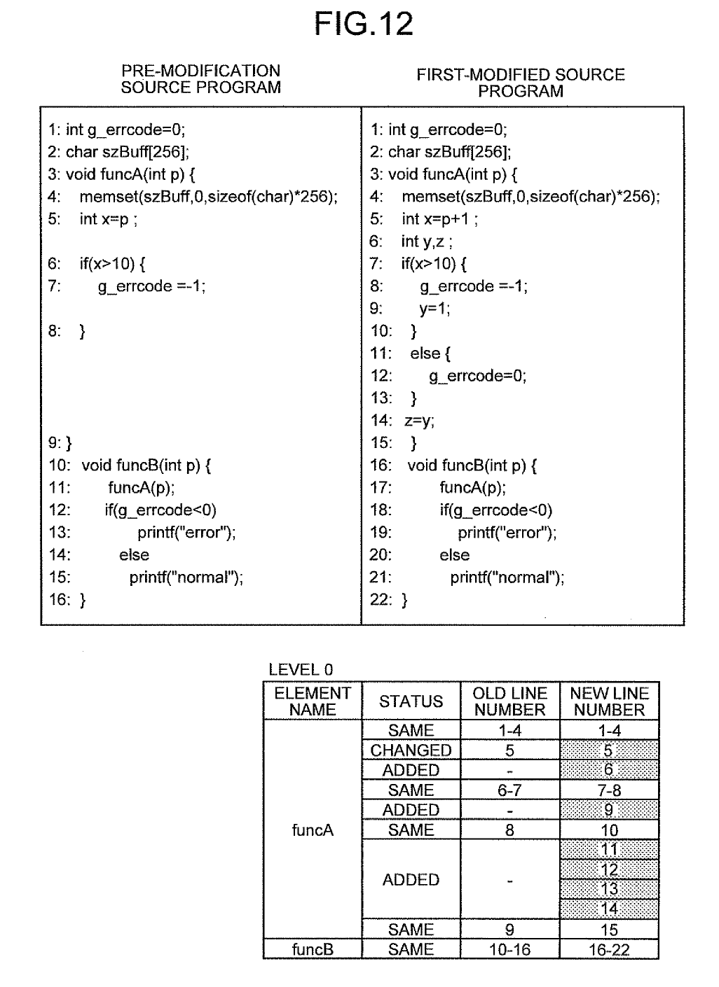

That is, as depicted in FIG. 12, the review-requiring-point extracting unit 15a compares the “first-modified source program” and the “pre-modification source program”, and extracts the “5th line” in which details of the function “funcA” are changed, and the “6th line”, the “9th line”, and the “11th to 14th lines” in which descriptions are added, as review-requiring points of the “level 0”.

The review-requiring-point extracting unit 15a then extracts influenced points for which processes described in the post-modification source program are influenced by the review-requiring points of the “level 0” classified according to levels of the influences.

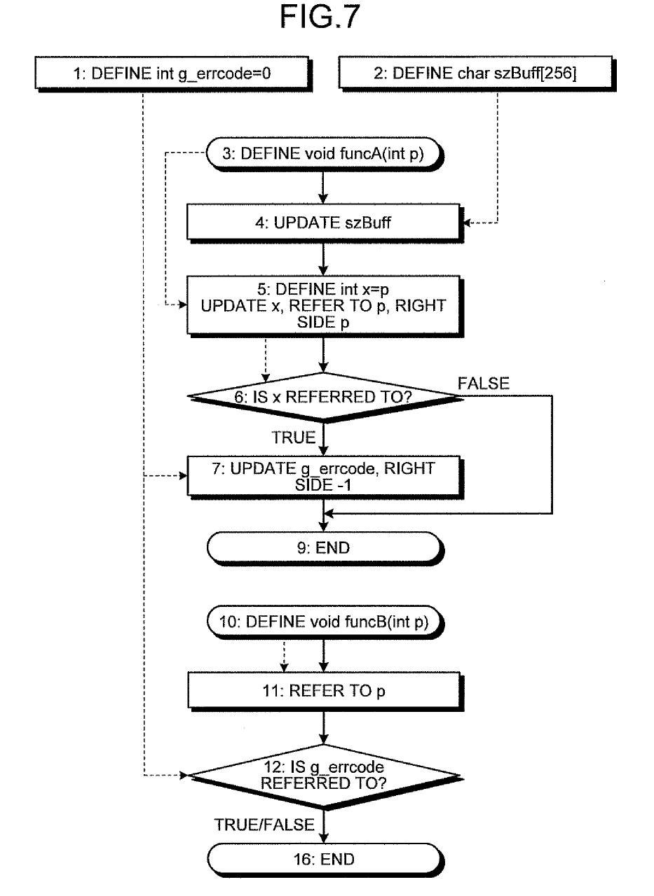

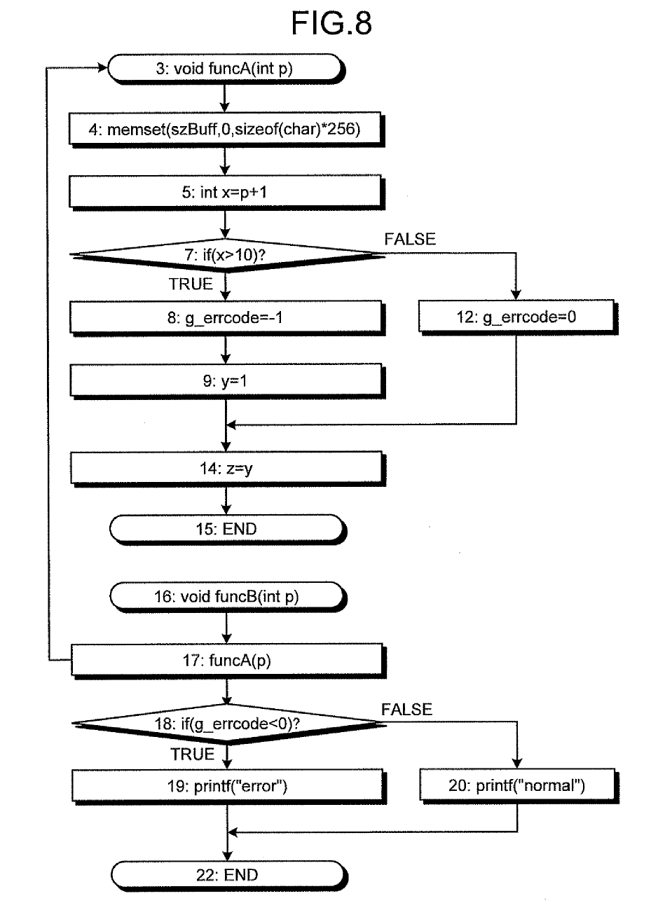

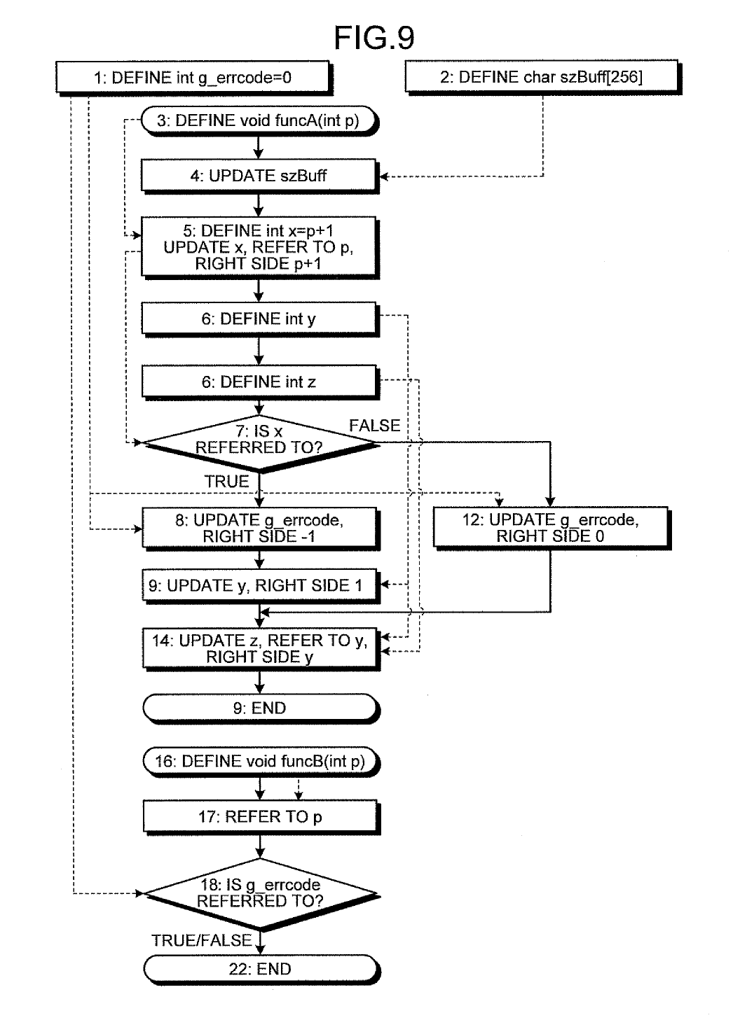

Specifically, the review-requiring-point extracting unit 15a statically analyzes the “pre-modification source program” depicted in FIG. 3 to create a “control flow” containing a flow of processes in the “pre-modification source program” as depicted in FIG. 6 and to create a “data flow” containing a flow of dependencies of processes of “define, refer, etc.” in the “pre-modification source program” as depicted in FIG. 7. The review-requiring-point extracting unit 15a further statically analyzes the “first-modified source program” depicted in FIG. 4 to create a “control flow” in the “first-modified source program” as depicted in FIG. 8 and to create a “data flow” in the “first-modified source program” as depicted in FIG. 9. In the “data flows” depicted in FIGS. 7 and 9, dashed arrows indicate reference relations between processes. That is, it is indicated that a process at an end of a dashed arrow is performed by referring to a result of a process at an origin of the dashed arrow.

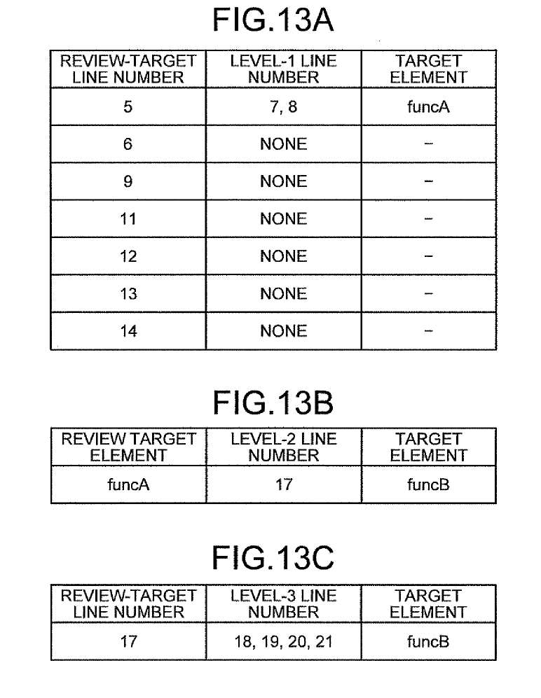

The review-requiring-point extracting unit 15a extracts influenced points for which process flows are influenced by points in which details of a function are changed out of the review-requiring points extracted as the “level 0”, by referring to the “control flow” and the “data flow” in the “pre-modification source program” and the “control flow” and the “data flow” in the “first-modified source program”, as review-requiring points of the “level 1”. That is, as depicted in FIG. 13A, the review-requiring-point extracting unit 15a extracts as the review-requiring points of the “level 1”, the “7th line” and the “8th line” as influenced points for which process flows are directly influenced by the point in the “5th line” in which details of the function “funcA” as a “target element” are changed out of “review-target line numbers” as the review-requiring points of the “level 0”. No review-requiring point of the “level 1” is extracted from the “6th line”, the “9th line”, and the “11th to 14th lines” which are the “review-target line numbers” as the review-requiring-points of the “level 0”.

Similarly, the review-requiring-point extracting unit 15a further extracts points referring to “changed functions” in the review-requiring points extracted as the “level 0”, as review-requiring points of the “level 2”, by referring to the “control flow” and the “data flow” in the “pre-modification source program” and the “control flow” and the “data flow” in the “first-modified source program”. That is, as depicted in FIG. 13B, the review-requiring-point extracting unit 15a extracts as the review-requiring point of the “level 2”, the “17th line” in which a process of the function “funcB” as a “target element” referring to the function “funcA” as a “review-target line element” is described.

Similarly, the review-requiring-point extracting unit 15a then extracts points influenced by the function out of the review-requiring points extracted as the “level 2”, as review-requiring points of the “level 3”, by referring to the “control flow” and the “data flow” in the “pre-modification source program” and the “control flow” and the “data flow” in the “first-modified source program”. That is, as depicted in FIG. 13C, the review-requiring-point extracting unit 15a extracts as the review-requiring points of the “level 3”, the “18th to 21st lines” as influenced points for which processes are directly influenced by the function “funcB” as the “target element” described in the “review-target line number: 17th line” which is the review-requiring point of the “level 2”.

The extraction-result storage unit 14b stores therein the review-requiring points extracted by the review-requiring-point extracting unit 15a. The extraction-result storage unit 14b stores therein the review-requiring points of the “level 0” to the “level 3” as depicted in FIGS. 12 and 13A to 13C, for example.

The review-history storage unit 14c stores therein a review history which is a history indicating whether each of the extracted review-requiring points has been reviewed or is unreviewed, associated with positional information in the post-modification source program.

That is, the review-history storage unit 14c stores therein a review history indicating whether each of the “5th line”, the “6th line”, the “9th line”, and the “11th to 14th lines” extracted as the review-requiring points of the “level 0”, the “7th line” and the “8th line” extracted as the review-requiring points of the “level 1”, the “17th line” extracted as the review-requiring point of the “level 2”, and the “18th to 21st lines” extracted as the review-requiring points of the “level 3” has been reviewed or is unreviewed. These review-requiring points of the “level 0” to the “level 3” are “unreviewed” until a review start request from the software developer is received, and accordingly the review-history storage unit 14c stores therein no data with respect to all items as depicted in FIG. 16A.

The information display unit 15b outputs information of the extracted review-requiring points associated with the stored review history indicating whether the review-requiring points have been reviewed or are unreviewed, to the output unit 12. The information display unit 15b receives a “level” designated by the software developer for the review-requiring points of the “level 0” to the “level 3” through a predetermined input unit, and displays the review-requiring points up to the designated “level”.

For example, when receiving a request from the software developer to ‘display all review-requiring points up to the “level 3”’, the information display unit 15b collectively displays the review-requiring points of the “level 0” to the “level 3” as depicted in FIGS. 12 and 13A to 13C in a “review-requiring-point list window” as depicted in FIG. 17. The “review-requiring-point list window” depicted in FIG. 17 displays that there are “seven” review-requiring points of the “level 0” based on the function “funcA”, which are all unreviewed, as “0 funcA 0/7”, and displays that there are “two” review-requiring points of the “level 1” based on the function “funcA”, which are all unreviewed, as “1 funcA 0/2”. The “review-requiring-point list window” also displays that there is “one” review-requiring point of the “level 2” based on the function “funcB”, which is unreviewed, as “2 funcB 0/1”, and that there are “four” review-requiring points of the “level 3” based on the function “funcB”, which are all unreviewed, as “3 funcB 0/4”. It is also displayed that all of the fourteen review-requiring points in total are unreviewed with “review record 0/14” at the bottom right. Reception of the request to ‘display all review-requiring points up to the “level 3”’ is displayed with the “level 3” at the top right.

When receiving a fact that the software developer presses a display portion of “0 funcA 0/7” in the “review-requiring-point list window” depicted in FIG. 17 from the input unit 11, the information display unit 15b displays a “review history” of the review-requiring points of the “level 0” in a “review history window”. The “review history window” depicted in FIG. 17 displays that the “5th line”, the “6th line”, the “9th line”, and the “11th to 14th lines” are all unreviewed and no data is stored, based on the data stored in the review-history storage unit 14c as depicted in FIG. 16A.

Further, the information display unit 15b also displays the “first-modified source program” in a “new source window” and the “pre-modification source program” in an “old source window” as depicted in FIG. 17. In the “new source window” depicted in FIG. 17, the information display unit 15b displays the review-requiring points with the “marks” placed at positions corresponding to the “level 0” to the “level 3”, respectively, on the left of the “line numbers” in the “first-modified source program”. The information display unit 15b displays the “outline rectangle (□)” indicating “unreviewed” as the “mark” to be placed.

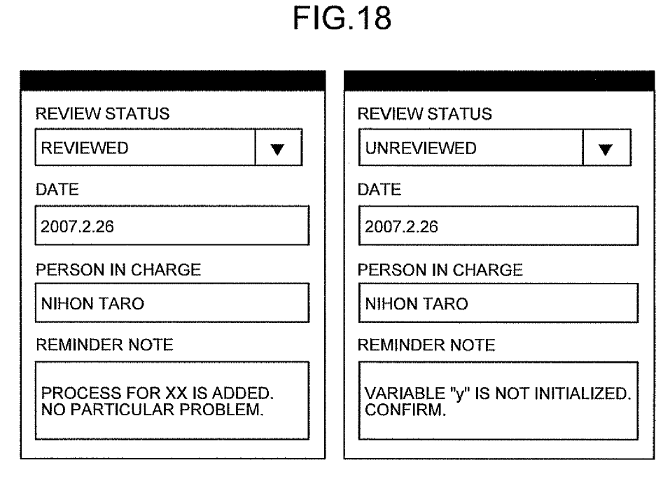

When receiving from the input unit 11 that the review-requiring points outputted as unreviewed on the monitor have been “reviewed”, the review-history update unit 15c updates the review history stored in the review-history storage unit 14c. For example, when the software developer “NIHON Taro” presses the “marks” of the “5th line”, the “9th line”, and the “11th to 14th lines” among the review-requiring points of the “level 0” in the “new source window” depicted in FIG. 17 on “Feb. 26, 2007” to display a “review status dialog” and inputs information for setting the “review status” as “reviewed” together with an “reminder note” to the effect that “Process described in design specifications is added. No particular problem.” (see the left side of FIG. 18), and presses the “mark” of the “6th line” among the review-requiring points of the “level 0” in the “new source window” depicted in FIG. 17 to display the “review status dialog” and inputs information for setting the “review status” as “unreviewed” together with an “reminder note” to the effect that “Variable “y” is not initialized. Confirm.” (see the right side of FIG. 18), the review-history update unit 15c receiving these inputs updates the review history as depicted in FIG. 16B.

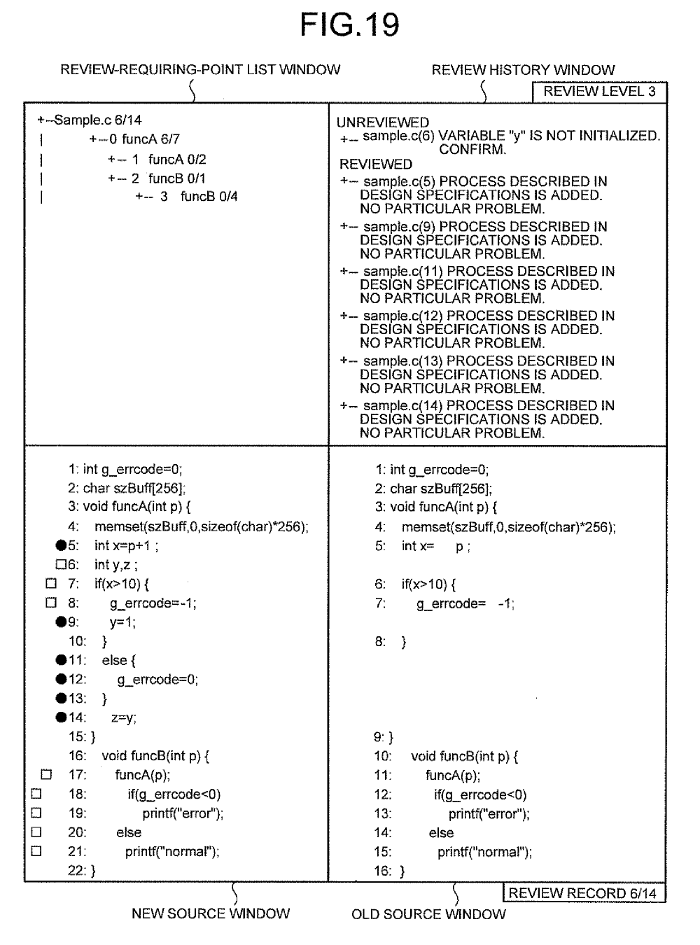

Upon update of the review history by the review-history update unit 15c as depicted in FIG. 16B, the information display unit 15b changes the screen displayed on the output unit 12 as depicted in FIG. 19. That is, the information display unit 15b changes the display in the “review history window” as depicted in FIG. 19, and further changes the “marks” of the “5th line”, the “9th line”, and the “11th to 14th lines” in the “new source window” from the “outline rectangles (□)” indicating “unreviewed” to the “black dots ()” indicating “reviewed”. The information display unit 15b changes “0 funcA 0/7” to “0 funcA 6/7” because “six” out of the “seven” review-requiring points of the “level 0” based on the function “funcA” in the “review-requiring-point list window” depicted in FIG. 17 have been “reviewed”. The information display unit 15b further changes the “review record” at the bottom right to “6/14”.

It is assumed here that the input unit 11 receives a review operation end request for the “first-modified source program” from the software developer in the situation depicted in FIG. 19, the software developer then creates a “second-modified source program” by modifying the “first-modified source program” based on the review result, and the “second-modified source program” is stored in the source-program storage unit 14a.

It is assumed for example that a software developer refers to the reminder note to the effect that “Variable “y” is not initialized. Confirm.” for the “6th line” as the review-requiring point of the “level 0” in the “review history window” depicted in FIG. 19, and modifies the “first-modified source program” depicted in FIG. 4 to create the “second-modified source program” depicted in FIG. 5. In this example, “6: int y,z;” in the “first-modified source program” is modified into two divided lines “6: int y=0;” and “7: int z=0;” in the “second-modified source program” as depicted in FIG. 5. The initial value of the variable “y” is set to “0” in the “6th line” and the initial value of the variable “z” is newly set to “0” in the “7th line”.

The review-requiring-point extracting unit 15a then compares the “second-modified source program” and the “first-modified source program”, and extracts review-requiring points associated with positional information (line numbers) in the “second-modified source program”.

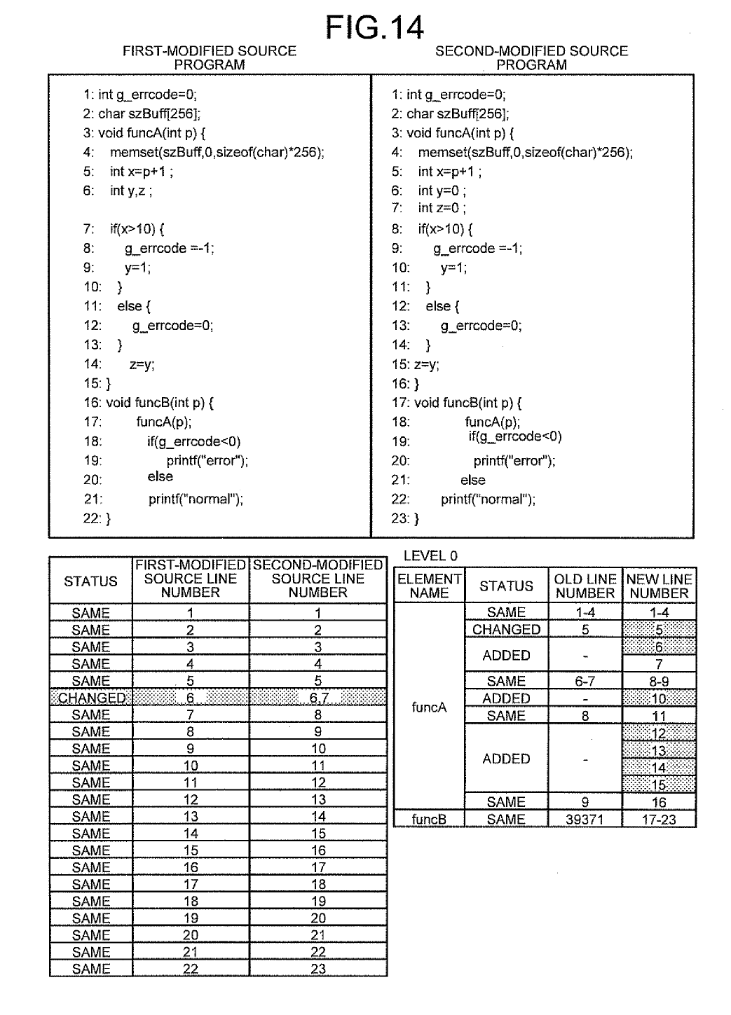

That is, the review-requiring-point extracting unit 15a compares the “second-modified source program” and the “first-modified source program”, as depicted in FIG. 14, and extracts the “5th line”, the “6th line”, the “9th line”, and the “11th to 14th lines” in the “first-modified source program” extracted as the review-requiring points of the “level 0”, associated with the “5th line”, the “6th line”, the “10th line”, and the “12th to 15th lines” as line numbers in the “second-modified source program”, respectively. The review-requiring-point extracting unit 15a also extracts the point in the “7th line” newly as a review-requiring point of the “level 0” in the “second-modified source program.”

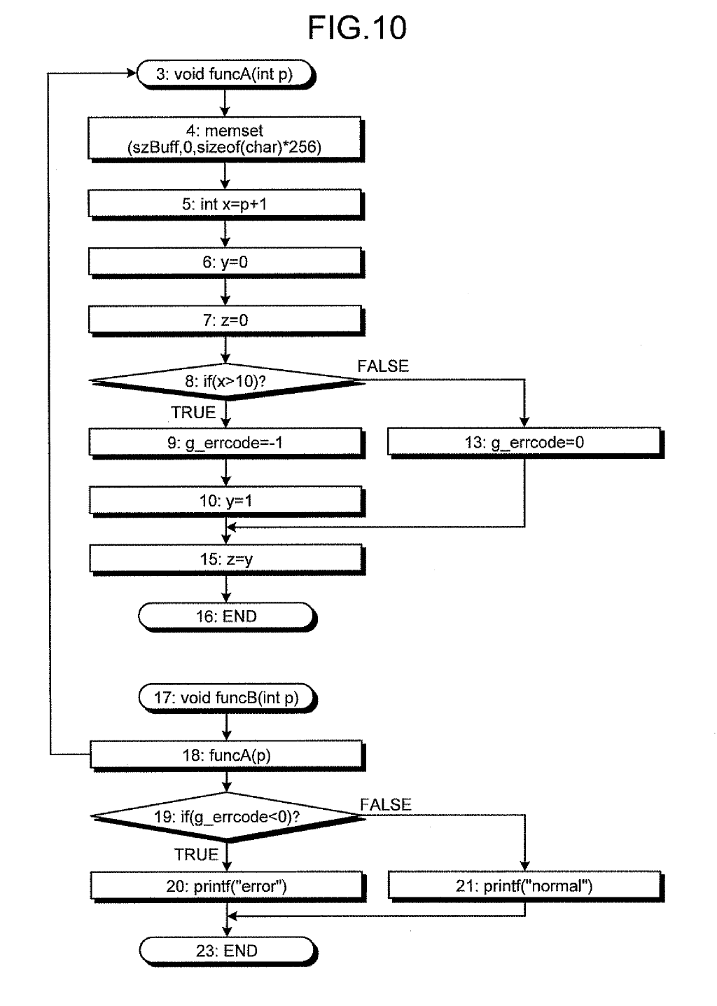

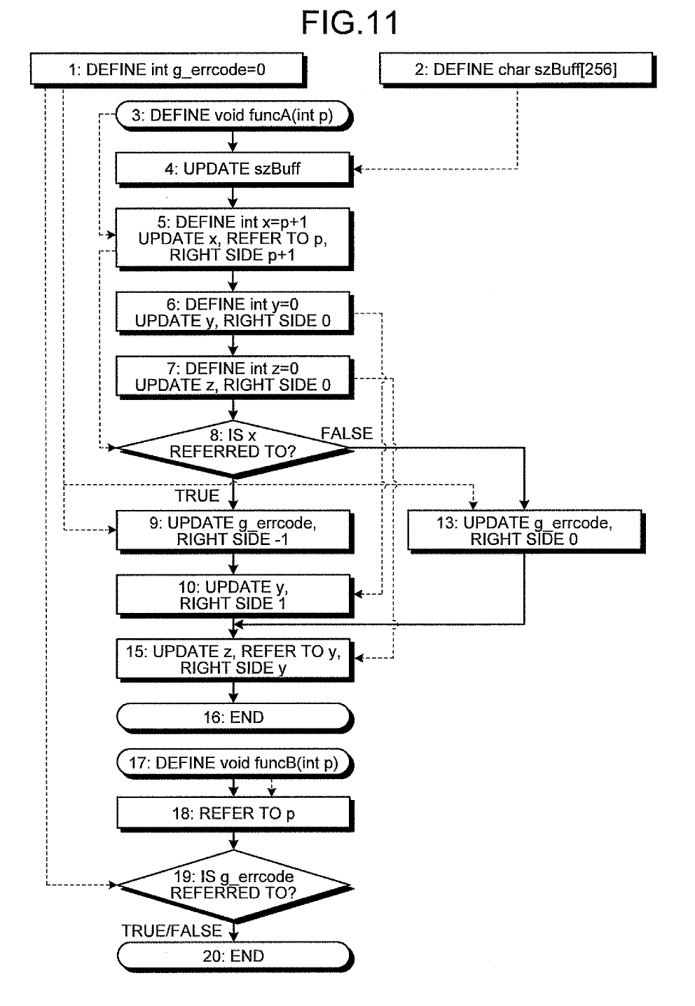

Further, the review-requiring-point extracting unit 15a further statically analyzes the “second-modified source program” depicted in FIG. 5 to create a “control flow” in the “second-modified source program” as depicted in FIG. 10 and create a “data flow” in the “second-modified source program” as depicted in FIG. 11. In the “data flow” depicted in FIG. 11, dashed arrows indicate reference relations between processes. That is, it is indicated that a process at an end of a dashed arrow is performed by referring to a result of a process at an origin of the dashed arrow.

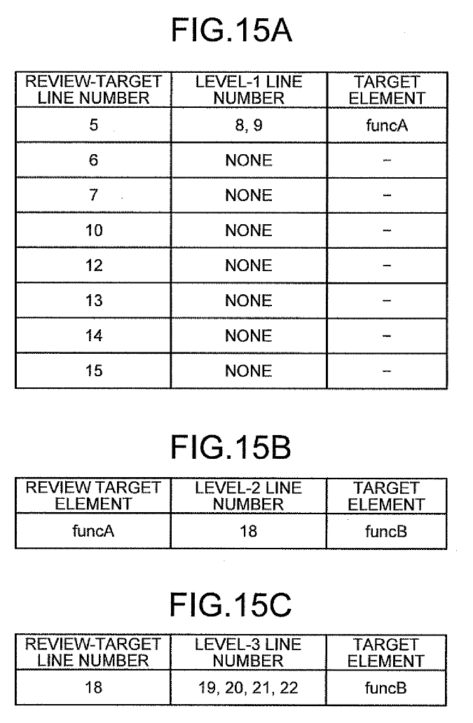

The review-requiring-point extracting unit 15a extracts the points in the “7th line” and the “8th line” extracted as the review-requiring points of the “level 1” in the “first-modified source program” (see FIG. 13A) associated with the “8th line” and the “9th line” as line numbers in the “second-modified source program”, as depicted in FIG. 15A, by referring to the “control flow” and the “data flow” newly created. The review-requiring-point extracting unit 15a also extracts the point in the “17th line” extracted as the review-requiring point of the “level 2” (see FIG. 13B) associated with the “18th line” as a line number in the “second-modified source program”, as depicted in FIG. 15B, and extracts the points in the “18th to 21st lines” extracted as the review-requiring points of the “level 3” in the “first-modified source program” (see FIG. 13C) associated with the “19th to 22nd lines” as line numbers in the “second-modified source program”, as depicted in FIG. 15C. The review-requiring-point extracting unit 15a stores the extraction results depicted in FIGS. 14 and 15A to 15C in the extraction-result storage unit 14b.

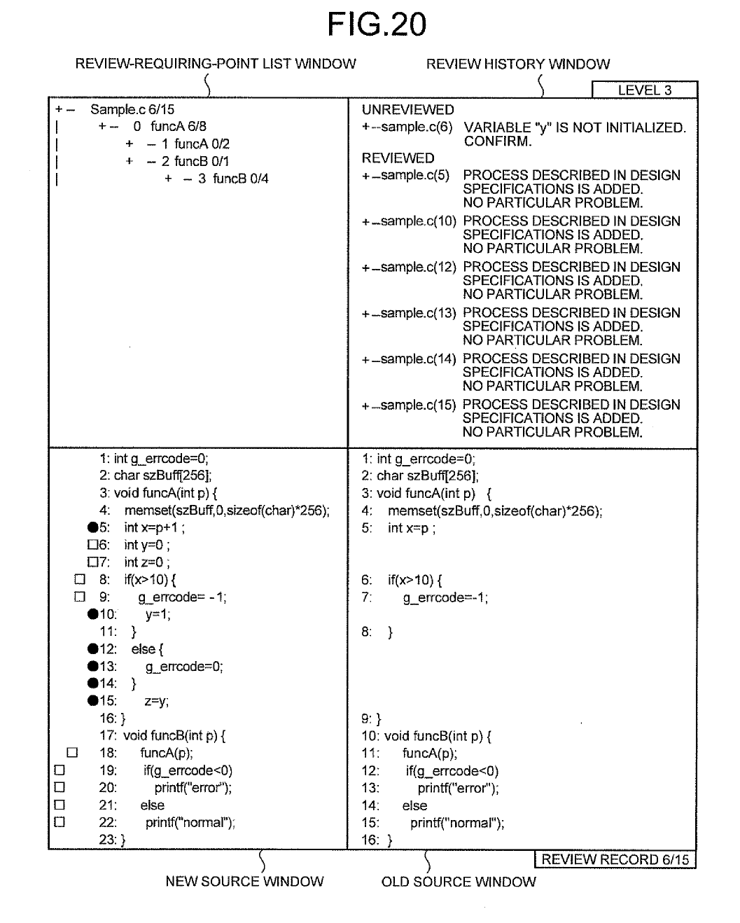

When receiving again the request to ‘display all review-requiring points up to the “level 3”’ from the software developer, the review-history update unit 15c updates the review history of the review-requiring points of the “level 0” as depicted in FIG. 16C based on the extraction results stored in the extraction-result storage unit 14b. The information display unit 15b displays a screen as depicted in FIG. 20 based on the review history updated by the review-history update unit 15c.

That is, a “review-requiring-point list window” depicted in FIG. 20 displays that the number of the review-requiring points of the “level 0” based on the function “funcA” becomes “eight” because of the addition of the “7th line” and “six” out of them have been “reviewed”, as “0 funcA 6/8”. The “review-requiring-point list window” also displays that there are “two” review-requiring points of the “level 1” based on the function “funcA”, which are all unreviewed, as “1 funcA 0/2”, there is “one” review-requiring point of the “level 2” based on the function “funcB”, which is unreviewed, as “2 funcB 0/1”, and there are “four” review-requiring points of the “level 3” based on the function “funcB”, which are all unreviewed, as “3 funcB 0/4”. The fact that “six” out of the fifteen review-requiring points in total have been “reviewed” is displayed with “review record 6/15” at the bottom right.

The information display unit 15b also displays the “second-modified source program” in the “new source window” and the “pre-modification source program” in the “old source window”, as depicted in FIG. 20. The information display unit 15b displays the review-requiring points with the “marks” placed at positions corresponding to the “level 0” to the “level 3”, respectively, on the left of the “line numbers” of the “second-modified source program” in the “new source window” depicted in FIG. 20. For example, the information display unit 15b displays the “mark” of the “outline rectangle (□)” indicating “unreviewed” for the “6th line” and the “7th line” in the “second-modified source program” as review-requiring points of the “level 0”.

### Process Procedure performed by Source Program Review Device according to First Embodiment

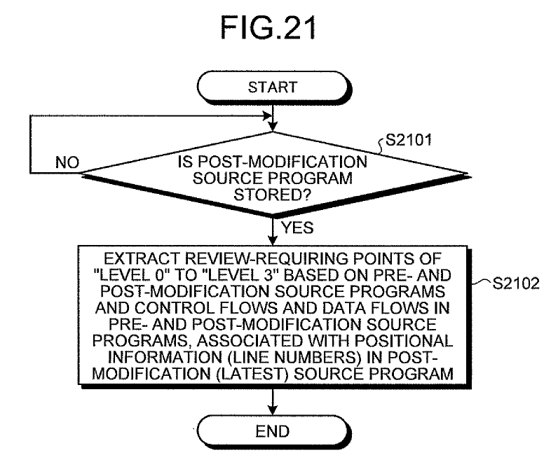

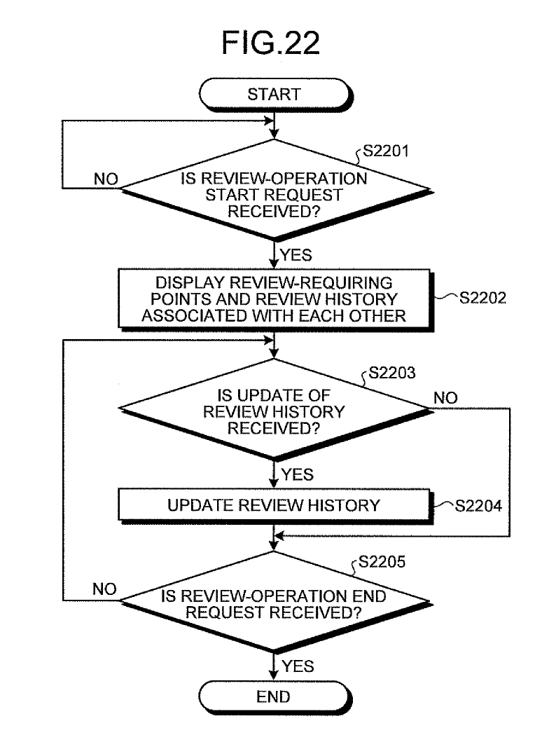

A process performed by the source program review device 10 according to the first embodiment is explained with reference to FIGS. 21 and 22. FIG. 21 is a schematic diagram for explaining a process of extracting review-requiring points by the source program review device 10. FIG. 22 is a schematic diagram for explaining a review-history updating process performed by the source program review device 10.

### Procedure of Review-Requiring-Point Extracting Process performed by Source Program Review Device According to First Embodiment

When a post-modification source program is stored in the source-program storage unit 14a of the source program review device 10 (YES at Step S2101 in FIG. 21), the review-requiring-point extracting unit 15a extracts review-requiring points of the “level 0” to the “level 3” based on source programs before and after a modification and the control flows and the data flows in the source programs before and after the modification, associated with positional information (line numbers) in the post-modification (latest) source program (Step S2102), and terminates the process.

For example, when the “first-modified source program” is stored, the review-requiring-point extracting unit 15a first compares the “pre-modification source program” depicted in FIG. 3 and the “first-modified source program” depicted in FIG. 4, and extracts the “5th line” in which details of the function “funcA” are changed and the “6th line”, the “9th line”, and the “11th to 14th lines” to which descriptions are added as the review-requiring points of the “level 0” as depicted in FIG. 12.

The review-requiring-point extracting unit 15a then statically analyzes the “pre-modification source program” depicted in FIG. 3 to create the “control flow” depicted in FIG. 6 and the “data flow” depicted in FIG. 7, and also statically analyzes the “first-modified source program” depicted in FIG. 4 to create the “control flow” depicted in FIG. 8 and the “data flow” depicted in FIG. 9. The review-requiring-point extracting unit 15a then refers to these flows, and extracts as the review-requiring points of the “level 1”, the “7th line” and the “8th line” as influenced points for which process flows are directly influenced by the point in the “5th line” in which the details of the function “funcA” as the “target element” are changed, among the “review-target line numbers” as the review-requiring points of the “level 0”, as depicted in FIG. 13A.

Further, the review-requiring-point extracting unit 15a further refers to the “control flow” and the “data flow” in the “pre-modification source program” and the “control flow” and the “data flow” in the “first-modified source program” similarly, and extracts as the review-requiring point of the “level 2”, the “17th line” in which the process of the function “funcB” as the “target element” that refers to the function “funcA” as the “review-target line element” is described, as depicted in FIG. 13B.

The review-requiring-point extracting unit 15a then refers to the “control flow” and the “data flow” in the “pre-modification source program” and the “control flow” and the “data flow” in the “first-modified source program” similarly, and extracts as the review-requiring points of the “level 3”, the “18th to 21st lines” as influenced points for which process flows are directly influenced by the function “funcB” as the “target element” described in the “review-target line number: 17” as the review-requiring point of the “level 2”, as depicted in FIG. 13C.

When the “second-modified source program” is stored, the review-requiring-point extracting unit 15a compares the “second-modified source program” and the “first-modified source program” as depicted in FIG. 14. The review-requiring-point extracting unit 15a then extracts the points in the “5th line” , the “6th line”, the “9th line”, and the “11th to 14th lines” extracted as the review-requiring points of the “level 0” in the “first-modified source program”, associated with the “5th line”, the “6th line”, the “10th line”, and the “12th to 15th lines” as the line numbers in the “second-modified source program”, and newly extracts the point in the “7th line” as the review-requiring point of the “level 0” in the “second-modified source program”.

Further, the review-requiring-point extracting unit 15a statically analyzes the “second-modified source program” as depicted in FIG. 5 to create the “control flow” in the “second-modified source program” as depicted in FIG. 10 and create the “data flow” in the “second-modified source program” as depicted in FIG. 11. The review-requiring-point extracting unit 15a then refers to the newly created “control flow” and “data flow”, and extracts the points in the “7th line” and the “8th line” extracted as the review-requiring points of the “level 1” in the “first-modified source program” associated with the “8th line” and the “9th line” as the line numbers in the “second-modified source program” as depicted in FIG. 15A. The review-requiring-point extracting unit 15a also extracts the point in the “17th” line extracted as the review-requiring point of the “level 2” associated with the “18th line” as the line number in the “second-modified source program” as depicted in FIG. 15B. The review-requiring-point extracting unit 15a also extracts the points in the “18th to 21st lines” extracted as the review-requiring points of the “level 3” in the “first-modified source program” associated with the “19th to 22nd lines” as the line numbers in the “second-modified source program” as depicted in FIG. 15C.

### Procedure of Review-History Update Process performed by Source Program Review Device according to First Embodiment

First, when the source program review device 10 receives a review-operation start request from the software developer (YES at Step S2201 in FIG. 22), the information display unit 15b displays the review-requiring points and the review history associated with each other (Step S2202).

That is, when receiving the review-operation start request to ‘display all review-requiring points up to the “level 3”’ from the software developer, the information display unit 15b displays the screen as depicted in FIG. 17 on the output unit 12, for example.

The review-history update unit 15c waits for receipt of update of the review history from the software developer (Step S2203). When receiving no update of the review history (NO at Step S2203), the review-history update unit 15c waits for receipt of a review-operation end request from the software developer (Step S2205).

On the other hand, when receiving update of the review history from the software developer (YES at Step S2203) the review-history update unit 15c updates the review history (Step S2204).

It is assumed for example that the software developer “NIHON Taro” presses the “marks” of the “5th line”, the “9th line”, and the “11th to 14th lines” among the review-requiring points of the “level 0” in the “new source window” depicted in FIG. 17 to display a “review status dialog” and inputs information for setting the “review status” as “reviewed” together with the “reminder note” to the effect that “Process described in design specifications is added. No particular problem.” (see left side of FIG. 18) on “Feb. 26, 2007”. It is also assumed that the software developer further presses the “mark” of the “6th line” among the review-requiring points of the “level 0” in the “new sour window” depicted in FIG. 17 to display the “review status dialog” and inputs information for setting the “review status” as “unreviewed” together with the “reminder note” to the effect that “Variable “y” is not initialized. Confirm.” (see right side of FIG. 18). In this case, the review-history update unit 15c receiving these inputs updates the review history as depicted in FIG. 16B. When the review-history update unit 15c updates the review history as depicted in FIG. 16B, the information display unit 15b changes the screen displayed on the output unit 12 as depicted in FIG. 19.

When receiving the review-operation end request from the software developer (YES at Step S2205), the source program review device 10 terminates the process.

### Effect of First Embodiment

As described above, according to the first embodiment, the pre-modification source program which is a source program before a modification and the post-modification source program which is a source program after the modification are compared, and the review-requiring points as points to be reviewed are extracted. The review history indicating whether each of the extracted review-requiring points has been reviewed or is unreviewed is stored in the review-history update unit 15c. The information of the extracted review-requiring points associated with the review history indicating whether they have been reviewed or are unreviewed and stored in the review-history update unit 15c is displayed on the output unit 12 (the monitor). When an input indicating that the review-requiring point displayed as unreviewed on the output unit 12 (the monitor) has been reviewed is received from the input unit 11, the review history stored in the review-history update unit 15c is updated. Therefore, the traces of reviews by each of the software developers can be left as the history and the points to be reviewed can be shared by the software developers. Accordingly, a highly-reliable review can be achieved.

According to the first embodiment, the review-requiring points are extracted associated with the positional information (line numbers) in the post-modification source program, and the review-history update unit 15c stores therein the review-requiring points associated with the positional information (line numbers) in the post-modification source program. Therefore, even when there is a difference between the positional information of the review-requiring points (specifically, between the line numbers in which the review-requiring points are described in the source programs) before and after the modification, the review history that reflects the updated positional information after the modification can be always created. Accordingly, a highly-reliable review can be achieved.

According to the first embodiment, the modified points in the post-modification source program that are modified from the pre-modification source program are extracted as the review-requiring points of the “level 0”, and influenced points for which processes described in the post-modification source program are influenced by the modified points are extracted as the review-requiring points of the “level 1”, the “level 2”, and the “level 3” classified according to levels of the influences. The points of a level received from the input unit 11 among the review-requiring points classified into the “level 0” to the “level 3” are then displayed by the output unit 12 as the review-requiring points. Therefore, the review-requiring points of a level according to needs of a client can be displayed, which enables the client to perform the review promptly. Accordingly, a highly-reliable review can be achieved.

### [b] Second Embodiment

While the source program review device according to the first embodiment has been explained above, the present invention can be embodied in various different forms other than the embodiment above described. Various different embodiments of a source program review device according to a second embodiment of the present invention are explained below in sections (1) to (3).

### (1) Review-Requiring Points

In the first embodiment, the case in which the review-requiring points are extracted at each storage of a latest source program has been explained. The present invention is not limited to this case, and the review-requiring points can be extracted upon receipt of a review-operation start request from a program developer, for example.

### (2) System Configuration and the Like

All or a part of the processes that have been explained as being performed automatically among the processes explained in the first embodiment can be performed manually (for example, the review-operation start request is not received from a program developer, but instead, generated automatically upon storage of a latest source program). All or a part of the processes that have been explained as being performed manually can be performed automatically in a well-known method. The process procedures, specific names, information including various data and parameters that have been described in the specifications and the drawings can be arbitrarily updated except as otherwise noted.

The respective constituent elements of the respective devices depicted in the drawings are functionally conceptual, and physically the same configuration as illustrated is not always necessary. That is, the specific mode (the mode of FIG. 2, for example) of distribution and integration of the processing units and storage units are not limited to the depicted ones, and all or a part thereof can be functionally or physically distributed or integrated in an arbitrary unit, according to various kinds of load and the status of use. For example, the information display unit 15b and the review-history update unit 15c may be integrated. In addition, all or an arbitrary part of processing functions performed by the respective devices can be realized by a central processing unit (CPU) and a program analyzed and executed by the CPU, or can be realized as hardware by a wired logic.

### (3) Source Program Review Program

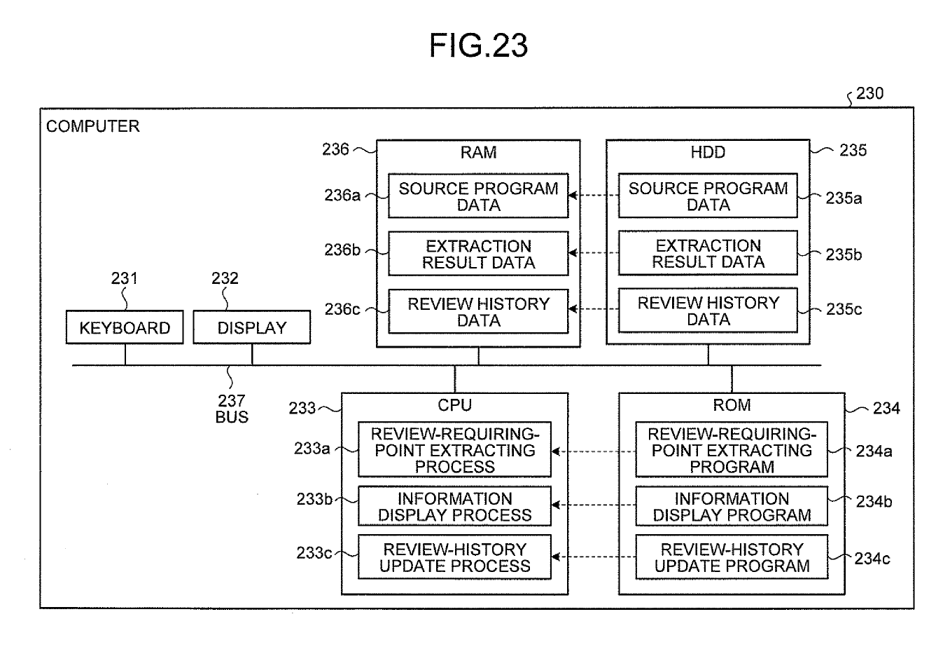

In the first embodiment, the case in which the processes are realized by hardware logic has been explained. However, the present invention is not limited to this case, and a program previously prepared can be executed by a computer. An example of a computer that executes a source program review program having the same function as that of the source program review device 10 according to the first embodiment is explained below with reference to FIG. 23. FIG. 23 depicts a computer that executes a source program review program according to the first embodiment.

As depicted in FIG. 23, a computer 230 as an information processor includes a keyboard 231, a display 232, a CPU 233, a read only memory (ROM) 234, a hard disk drive (HDD) 235, and a random access memory (RAM) 236, which are connected via a bus 237 or the like.

A source program review program that provides the same function as that of the source program review device 10 according to the first embodiment, that is, a review-requiring-point extracting program 234a, an information display program 234b, and a review-history update program 234c as depicted in FIG. 23 are previously stored in the ROM 234. The programs 234a to 234c can be properly integrated or distributed like the constituent elements of the source program review device 10 depicted in FIG. 2.

The CPU 233 reads the programs 234a to 234c from the ROM 234 and executes the programs, so that the programs 234a to 234c function as a review-requiring-point extracting process 233a, an information display process 233b, and a review-history update process 233c, respectively, as depicted in FIG. 23. The processes 233a to 233c correspond to the review-requiring-point extracting unit 15a, the information display unit 15b, and the review-history update unit 15c depicted in FIG. 2, respectively.

Source program data 235a, extraction result data 235b, and review history data 235c are stored in the HDD 235 as depicted in FIG. 23. The source program data 235a correspond to the source-program storage unit 14a depicted in FIG. 2, the extraction result data 235b correspond to the extraction-result storage unit 14b depicted in FIG. 2, and the review history data 235c correspond to the review-history storage unit 14c depicted in FIG. 2. The CPU 233 registers source program data 236a with the source program data 235a, extraction result data 236b with the extraction result data 235b, and review history data 236c with the review history data 235c. The CPU 233 then reads the source program data 236a, the extraction result data 236b, and the review history data 236c, stores the read data in the RAM 236, and performs a source program review process based on the source program data 236a, the extraction result data 236b, and the review history data 236c stored in the RAM 236.

It is not always necessary to store the programs 234a to 234c in the ROM 234 from the start. The programs 234a to 234c can be stored in a “portable physical medium” to be inserted into the computer 230 such as a flexible disk (FD) a compact disk read only memory (CD-ROM), a magneto-optical (MO) disk, a digital versatile disk (DVD), and an integrated circuit (IC) card, a “fixed physical medium” such as a HDD provided inside or outside of the computer 230, or “another computer (or a server)” connected to the computer 230 via a public line, the Internet, a local area network (LAN), or a wide area network (WAN), or the like. The computer 230 then can read the programs 234a to 234c and execute the read programs.

According to one embodiment, traces of reviews by each software developer can be left as the history and the points to be reviewed can be shared by the software developers. Therefore, a highly-reliable review can be achieved.

According to one embodiment, even when there is a difference between the positional information of the review-requiring points (specifically, line numbers in which the review-requiring points are described in the source programs) before and after a modification, the review history that reflects the updated positional information after the modification can be always created. Therefore, a highly-reliable review can be achieved.

According to one embodiment, the review-requiring points of a level according to needs of a client can be displayed, which enables the client to perform a prompt review. Therefore, a highly-reliable review can be achieved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer readable storage medium storing a program that causes a computer to perform a method for reviewing a modified source program, the program causing the computer to perform the method comprising:
extracting review-requiring points to be reviewed, by comparing a pre-modification source program as a source program before a modification and a post-modification source program as a source program after the modification;
storing a review history indicating whether each of the review-requiring points extracted in the extracting has been reviewed or is unreviewed, in a predetermined storage unit;
outputting information of the review-requiring points extracted in the extracting, associated with the review history stored in the predetermined storage unit and indicating whether each of the review-requiring points has been reviewed or is unreviewed, to a predetermined output unit; and
updating the review history stored in the predetermined storage unit when receiving from a predetermined input unit that the review-requiring point outputted as unreviewed by the predetermined output unit has been reviewed.

2. The computer readable storage medium according to claim 1, wherein
the review-requiring points are extracted associated with positional information in the post-modification source program in the extracting, and
the review-requiring points are stored associated with the positional information in the post-modification source program in the storing.

3. The computer readable storage medium according to claim 2, wherein
modified points in the post-modification source program that are modified from the pre-modification source program, and influenced points for which processes described in the post-modification source program are influenced by the modified points, classified according to levels of influences are extracted as the review-requiring points in the extracting, and
a point received from a predetermined input unit among the modified points and the influenced points classified according to the levels is outputted as the review-requiring point in the outputting.

4. A method for reviewing a modified source program, the method comprising:
extracting review-requiring points to be reviewed, by comparing a pre-modification source program as a source program before a modification and a post-modification source program as a source program after the modification;
storing a review history indicating whether each of the review-requiring points extracted at the extracting has been reviewed or is unreviewed;
outputting information of the review-requiring points extracted in the extracting, associated with the review history stored in the storing and indicating whether each of the review-requiring points has been reviewed or is unreviewed, to a predetermined output unit; and
updating the review history stored in the storing when receiving from a predetermined input unit that the review-requiring point outputted as unreviewed by the predetermined output unit has been reviewed.

5. The method according to claim 4, wherein
the review-requiring points are extracted associated with positional information in the post-modification source program in the extracting, and
the review-requiring points are stored associated with the positional information in the post-modification source program in the storing.

6. The method according to claim 5, wherein
modified points in the post-modification source program that are modified from the pre-modification source program, and influenced points for which processes described in the post-modification source program are influenced by the modified points, classified according to levels of influences are extracted as the review-requiring points in the extracting, and
a point received from a predetermined input unit among the modified points and the influenced points classified according to the levels is outputted as the review-requiring point in the outputting.

7. A device for reviewing a modified source program, the device comprising:
a review-requiring-point extracting unit that extracts review-requiring points to be reviewed, by comparing a pre-modification source program as a source program before a modification and a post-modification source program as a source program after the modification;
a review-history storage unit that stores therein a review history indicating whether each of the review-requiring points extracted by the review-requiring-point extracting unit has been reviewed or is unreviewed;
an information output unit that outputs information of the review-requiring points extracted by the review-requiring-point extracting unit, associated with the review history stored in the review-history storage unit and indicating whether each of the review-requiring points has been reviewed or is unreviewed, to a predetermined output unit; and
a review-history update unit that updates the review history stored in the review-history storage unit when receiving from a predetermined input unit that the review-requiring point outputted as unreviewed by the predetermined output unit has been reviewed.

8. The device according to claim 7, wherein
the review-requiring-point extracting unit extracts the review-requiring points associated with positional information in the post-modification source program, and
the review-history storage unit stores therein the review-requiring points associated with the positional information in the post-modification source program.

9. The device according to claim 8, wherein
the review-requiring-point extracting unit extracts modified points in the post-modification source program that are modified from the pre-modification source program, and influenced points for which processes described in the post-modification source program are influenced by the modified points, classified according to levels of influences, as the review-requiring points, and
the information output unit outputs a point received from a predetermined input unit among the modified points and the influenced points classified according to the levels, as the review-requiring point.
